(19) United States
(12) Patent Application Publication
(10) Pub. No.: US 2009/0280801 A1
(43) Pub. Date: Nov. 12, 2009

(54) Cell Sensor for Access Ports

(76) Inventor: Ajay MALIK, Santa Clara, CA (US)

Correspondence Address: MOTOROLA, INC., 1303 EAST ALGONQUIN ROAD, IL01/3RD, SCHAUMBURG, IL, 60196, US

(21) Appl. No.: 12/118,126

(22) Filed: May 9, 2008

(51) Int. Cl. H04Q 7/20

(52) U.S. Cl. 455/426.1

(57) ABSTRACT

A system may include (a) a mobile device configured to operate in a first mode and a second mode, the first mode operating with a first protocol of a first network, the second mode operating with a second protocol of a second network; and (b) an access port of the first network configured to receive signals transmitted from the mobile device while the mobile device is operating in the first mode. The access port is equipped with a sensor that receives the signals transmitted from the mobile device while the mobile device is operating in the second mode.

### FIELD OF THE INVENTION

The present invention relates generally to a cell sensor for access ports. Specifically, the cell sensor enables the access port to locate a mobile device that is operating as a cellular phone.

### BACKGROUND

A location of a mobile unit may be a very useful parameter to determine while the mobile unit is operating. For example, the location of the mobile unit may be used as a basis to provide directions, to associate with an intermediary network device to provide an optimum connection, etc. The mobile unit may be equipped to communicate using a variety of operating modes using different protocols. For example, the mobile unit may communicate in a wireless network with WiFi using at least one of the 802.11 standards. In another example, the mobile unit may communicate in a cellular network as a cellular phone. When communicating in a specific type of network, the mobile unit may use a specific protocol that another specific type of network is not configured to interpret.

The operating mode of the mobile unit may determine how the mobile unit is located. With WiFi devices, an access port in a network with which the WiFi device is associated may perform the locating using a variety of locating methods such as triangulation, received signal strength indication, global positioning system, etc. With cellular phones, a cell tower in which the cellular phone is associated may receives signals that are used perform the locating using substantially similar methods listed above. However, if the device is operating as a cellular phone only (e.g., no WiFi connectivity), but remains disposed within an operating area of an access port, the location of the mobile unit cannot be determined by the WiFi network since the access port is not configured to make the location determination while the mobile unit is operating as a cellular phone.

### SUMMARY OF THE INVENTION

The present invention relates to a cell sensor for access ports. In particular, a system according to an exemplary embodiment of the present invention may include (a) a mobile device configured to operate in a first mode and a second mode, the first mode operating with a first protocol of a first network, the second mode operating with a second protocol of a second network; and (b) an access port of the first network configured to receive signals transmitted from the mobile device while the mobile device is operating in the first mode. The access port is equipped with a sensor that receives the signals transmitted from the mobile device while the mobile device is operating in the second mode.

### DESCRIPTION OF THE DRAWINGS

FIG. 1 shows a WiFi network according to an exemplary embodiment of the present invention.

FIG. 2 shows a cellular network in which a plurality of WiFi networks are disposed according to an exemplary embodiment of the present invention.

FIG. 3 shows a method for determining a location of a mobile unit according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a cell sensor for an access port (AP). According to the exemplary embodiments of the present invention, the cell sensor enables the AP that is part of a WiFi network to locate a mobile unit (MU) while the MU is operating in a cellular network as a cellular phone. The AP, the sensor, the MU, the networks, and an associated method will be discussed in further detail below.

It should be noted that the MU may be any portable electronic device such as a mobile computer, a personal digital assistant (PDA), a laptop, a cell phone, a radio frequency identification reader, a scanner, an image capturing device, a pager, etc. The MU may include various components such as a processor, a memory, a battery, a transceiver, an antenna, etc. The MU may be a dual mode MU. That is, the MU may be equipped to operate in two modes, as a WiFi device and as a cellular phone. It should also be noted that the use of the cellular phone is only exemplary. The sensor may be configured to locate the MU while the MU is operating in other modes (e.g., not as a WiFi device).

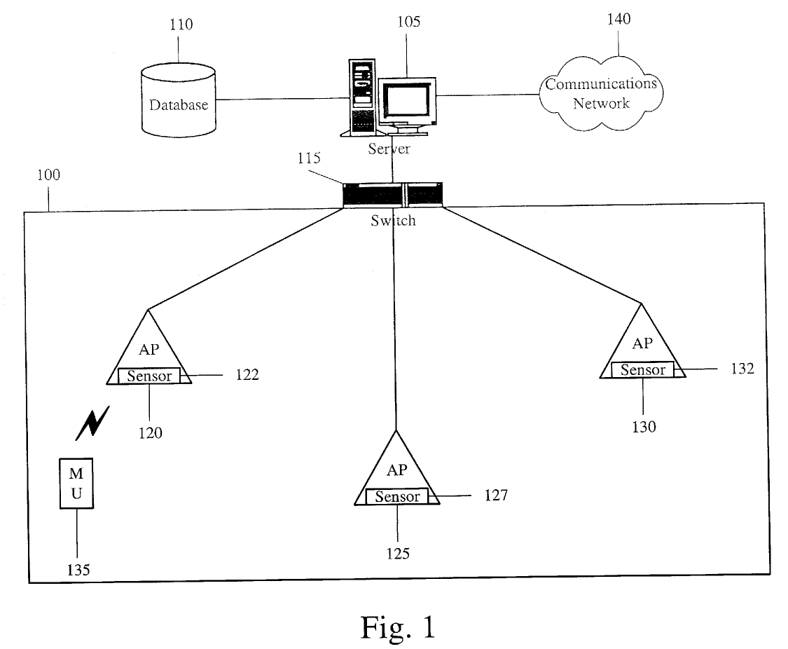

FIG. 1 shows a WiFi network 100 according to an exemplary embodiment of the present invention. The WiFi network 100 may operate using, for example, any of the 802.11 standards. An MU 135 may be associated with the WiFi network 100. It should be noted that the network being a WiFi network is only exemplary. As will be explained in further detail below, the WiFi network 100 may be any other type of network that is not substantially similar to another network in which the MU 135 may also be associated. The WiFi network 100 may include a server 105, a database 110, a switch 115, and access ports (AP) 120, 125, 130.

The server 105 may be configured to be responsible for the operations occurring within the network 100. Specifically, the server 105 may execute a location determining functionality to ascertain a location of the MU 135. The location determining functionality may include, for example, a triangulation, a received signal strength indication (RSSI), a global positioning system (GPS), etc. The location determining functionality of the server 105 may include known parameters that are compared with parameters included in signals transmitted from the MU 135 to determine the location of the MU 135. The location determining functionality may be a program that is stored in the database 110 with the known parameters. The database 110 may store other data relating to the network 100 such as association lists. The network 100 may further include the switch 115 to direct data appropriately. For example, the signals transmitted from the MU 135 including the parameters may be determined by the switch 115 to be forwarded to the server 105. It should be noted that the switch 115 may be configured to execute the location determining functionality.

The network 100 may incorporate the APs 120, 125, 130 to extend a coverage area so that the MU 135 may connect to the network 100 in a greater number of locations. The APs 120, 125, 130 contain an individual coverage area that is part of an overall coverage area of the network 100. That is, the APs 120, 125, 130 may serve as an intermediary for a transmission from the MU 135 to the server 105. As illustrated, the MU 135 is wirelessly associated with the network 100 via the AP 120. However, if the MU 135 roams to another coverage area, the MU 135 may be associated with the network 100 via the other APs 125, 130. It should be noted that the network 100 may include further APs to further extend the coverage area of the network 100. The APs 120, 125, 130 may be, for example, WiFi Thin APs or Adaptive APs.

As discussed above, the MU 135 may be operate in at least two modes (e.g., a dual mode MU). As illustrated in FIG. 1, the MU 135 may be operating using a protocol of the network 100. That is, one of the modes in which the MU 135 may operate is the protocol of the network 100. Because the network 100 is a WiFi network, the MU 135 may be operating using any of the 802.11 standards. Thus, the MU 135 may transmit signals in which the AP 120 is configured to receive. The AP 120 may subsequently forward the received signals to the switch 115 which forwards the signals to the server 105. The signals may include parameters of the MU 135 so that the server 105 may execute the location determining functionality to ascertain the location of the MU 135.

The server 105 may further be connected to a communications network 140. The communications network 140 may include a gateway in which a communication is transmitted onto other networks from the server 105. For example, the MU 135 may be configured to include a communications functionality such as a telephone. The server 105 may be connected to a telephone network via the gateway of the communications network 140. Using the association with the network 100, the MU 135 may forward voice packets to the server 105 which forwards the voice packets to the telephone network.

As will be described in further detail below, the MU 135 may also operate in another mode. Specifically, the MU 135 may be operating using a protocol that is substantially different from the protocol of the network 100. For example, the MU 135 may be operating as a cellular phone. In such an exemplary embodiment, the MU 135 may be broadcasting signals that the APs 120, 125, 130 are not configured to receive. Consequently, the server 105 also does not receive the signals from the MU 135 to determine the location of the MU 135.

According to the exemplary embodiments of the present invention, each of the APs 120, 125, 130 may be equipped with sensors 122, 127, 132, respectively. In the exemplary embodiment where the MU 135 is operating as a cellular phone (i.e., not using the protocol of the network 100), the sensors 122, 127, 132 may be, for example, cellular sensors. That is, the sensors 122, 127, 132 may be configured to receive signals broadcasted from the MU 135 while the MU 135 is operating as a cellular phone. Thus, the APs 120, 125, 130 may further be configured to receive signals from the MU 135 regardless of the operating mode of the MU 135. In a first exemplary embodiment, the sensors 122, 127, 132 may each include a dedicated transceiver and antenna to receive signals broadcasted from the MU 135 using the other protocol (e.g., cellular). In a second exemplary embodiment, the sensors 122, 127, 132 may be coupled with the respective AP so that the transceiver and antenna of the AP are further used by the respective sensor. In either embodiment, the sensors 122, 127, 132 may be incorporated into the respective AP or may be a module that couples to the respective AP. Therefore, the sensors 122, 127, 132 may be designed to be a component of the respective AP that is housed therein or may add an additional functionality to the respective AP by connecting as a module via a connector such as a universal serial bus (USB) port.

It should be noted that if the sensors 122, 127, 132 are equipped with respective, dedicated transceivers and antennas, the coverage area of the sensors 122, 127, 132 may be different from the coverage area of the respective AP in which the sensors 122, 127, 132 are a part. For example, the transceivers and antennas of the sensors 122, 127, 132 may broadcast further to encompass a greater coverage area than that provided by the AP. Those skilled in the art will understand that a coverage area provided by a cellular network may be greater than a coverage area provided by the WiFi network 100. Thus, there is a probability that the MU 135 may roam into an area that is not part of the coverage area provided by the WiFi network 100. The coverage areas of sensors 122, 127, 132 may compensate at least partially for the greater coverage area of the cellular network in which the MU 132 may be disposed. In another example, the WiFi network 100 may be aware that a cellular network only encompasses a portion of the coverage area of the WiFi network 100. The coverage area of the sensors 122, 127, 132 may be smaller than that of the AP but large enough to cover the portion in which the cellular network overlaps with the coverage area of the WiFi network 100.

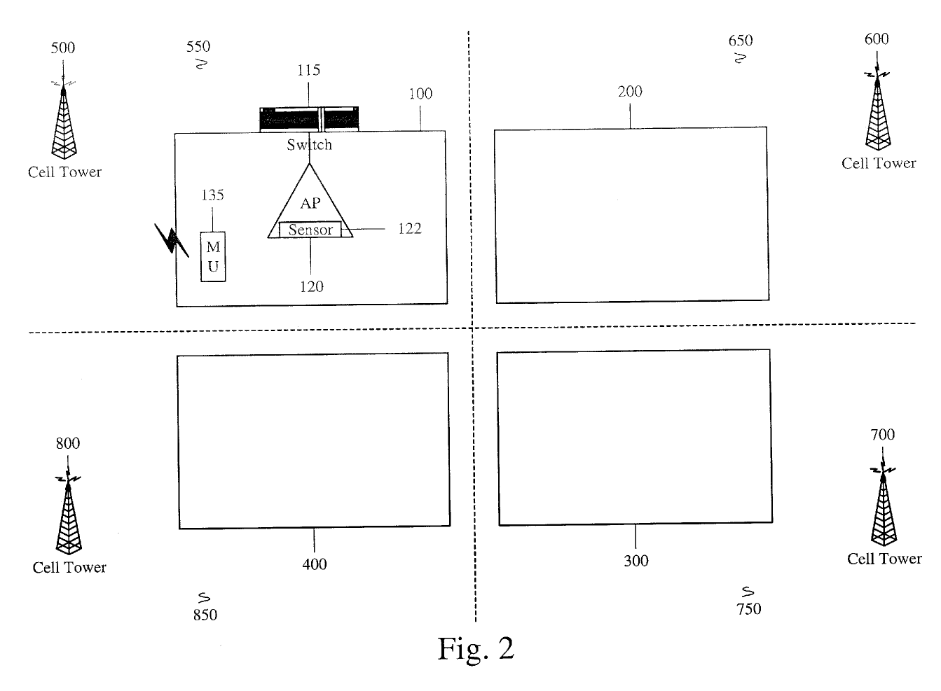

FIG. 2 shows a cellular network in which a plurality of WiFi networks 100, 200, 300, 400 are disposed according to an exemplary embodiment of the present invention. The cellular network may include a plurality of coverage areas 550, 650, 750, 850 that are provided by strategically placed cell towers 500, 600, 700, 800, respectively.

It should be noted that the configuration of the WiFi networks 100, 200, 300, 400 and the coverage areas 550, 650, 750, 850 is only exemplary. Those skilled in the art will understand that when the protocols, administrators, operators, etc. of a network may not deploy the network considering other networks to be deployed in an area. Thus, the WiFi networks 100, 200, 300, 400 being disposed wholly within the coverage areas 550, 650, 750, 850 are only exemplary. For example, the WiFi network 100 may be disposed at least partially in multiple coverage areas of the cellular network. It should also be noted that the coverage areas 550, 650, 750, 850 including boundaries that do not overlap are only exemplary. Those skilled in the art will understand that the cell towers 500, 600, 700, 800 may include a respective coverage area that radiates from the cell towers. Thus, the coverage area may be a substantially circular area. Consequently, the coverage areas may overlap or include gaps.

As discussed above with reference to FIG. 1, the MU 135 may be disposed in the coverage area of the WiFi network 100. However, according to the exemplary embodiment of FIG. 2, the MU 135 may be operating in the other mode. That is, the MU 135 is not operating using the protocol of the WiFi network 100 but is operating as a cellular phone. Specifically, the MU 135 is associated with the cellular network via the cell tower 500 since the MU 135 is also disposed in the coverage area 550.

As a result, since the cellular network is configured to receive the signals from the MU 135, the cellular network is capable of determining a location of the MU 135 in a substantially similar manner as the server 105 when the MU 135 was operating using the protocol of the WiFi network 100 (e.g., triangulation, RSSI, GPS, etc.). However, according to the exemplary embodiments of the present invention, even though the MU 135 is operating as a cellular phone and associated with the cellular network, the AP 120 equipped with the sensor 122 may receive the signals broadcasted from the MU 135. Since the sensor 122 is configured to receive cellular signals, according to a first exemplary embodiment, the server 105 may be forwarded these signals including parameters of the MU 135 so that the server 105 and the WiFi network 100 may also determine the location of the MU 135. According to a second exemplary embodiment, the sensor 122 may be configured to receive the cellular signals from the MU 135 and determine the location. Consequently, data relating to the location of the MU 135 may be forwarded to the server 105. Thus, according to the exemplary embodiments of the present invention, the WiFi network 100 may determine the location of the MU 135 whether the MU 135 is operating in either mode (e.g., WiFi or cellular) since the AP 120 is configured to receive WiFi signals and the sensor 122 is configured to receive cellular signals.

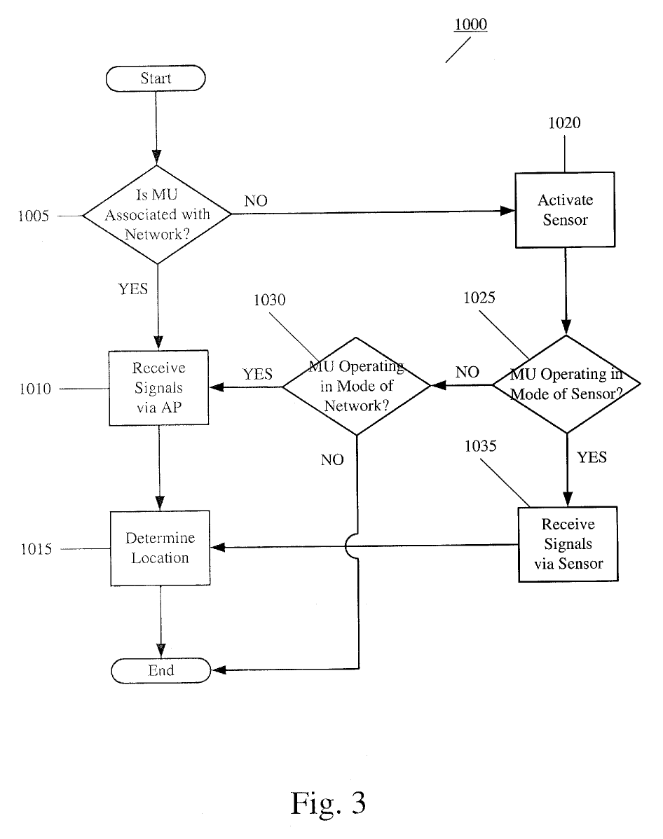

FIG. 3 shows a method 1000 for determining a location of an MU according to an exemplary embodiment of the present invention. The method 1000 may relate to determining the location of the MU 135 that operates in at least two modes such as WiFi and cellular. It should be noted that the method 1000 is described below with a perspective of the WiFi network 100, in particular relating to the server 105. The method 1000 will be described with reference to the WiFi network 100 of FIG. 1 and the cellular network of FIG. 2.

In step 1005, determination is made whether the MU 135 is associated with the WiFi network 100. Specifically, the determination may relate to whether the MU 135 is operating with a protocol of the WiFi network 100. Thus, the determination may indicate whether or not the AP 120 is configured to receive signals broadcasted by the MU 135.

The determination may be made in a variety of manners. In a first exemplary embodiment, the MU 135 and the server 105 may have performed a handshake operation to initially associate the MU 135 with the WiFi network 100. The association may be stored in a database of currently associated MUs on the WiFi network 100. The server 105 may continuously monitor the association to ensure that the MU 135 is still associated with the network by sending a query signal and receiving a reply signal. Thus, if the MU 135 is still part of the database of currently associated MUs, the server 105 may determine that the MU 135 is operating part of the WiFi network 100 and operating using the protocol of the WiFi network 100. If the MU 135 is no longer part of the database of currently associated MUs, an opposite conclusion may be drawn. In a second exemplary embodiment, if no database of currently associated MUs is available (e.g., the WiFi network 100 is a public network available to any device with a transceiver), the server 105 may send the query signal to identify the MU 135 or all the MUs that are associated with the WiFi network 100. If the server 105 receives the reply signal from the MU 135, the server 105 is aware that the MU 135 is associated with the WiFi network 100 and operating using the protocol of the WiFi network 100. If no reply signal is received from the MU 135, the query signal may be broadcast repeatedly until a predetermined time period lapses. If no reply signal is received, an opposite conclusion may be drawn.

If it is determined that the MU 135 is associated with the WiFi network 100, the method 1000 continues to step 1010 where signals from the MU 135 are received via the AP 120 (i.e., a component of the WiFi network 100 in which the MU 135 is directly associated). The signals may include parameters relating to the MU 135. For example, the parameters may be data directly related to the MU 135. The signals may also be used to extract parameters relating to the MU 135. For example, a time to transmit from the MU 135 and receive by the AP 120 may indicate a relative distance, a signal strength, etc. in which the parameters relating to the MU 135 are determined.

Upon receiving the signals via the AP, the method 1000 continues to step 1015 where the location of the MU 135 is determined using any of the above described manners such as triangulation, RSSI, and GPS. It is noted that when the MU 135 is associated with the WiFi network 100, the location of the of the MU 135 may be assumed to be within the coverage area of the WiFi network 100 provided through the server 105 and the APs 120, 125, 130.

Returning to step 1005, if it is determined that the MU 135 is not associated with the WiFi network 100, the method 1000 continues to step 1020 where the sensor 122 is activated. It should be noted that the sensor 122 may be deactivated when not in use to minimize an amount of power to be used. Thus, the sensor 122 may be activated in step 1020. However, it should also be noted that the sensor 122 may be activated permanently or whenever the AP 120 is active. In such an exemplary embodiment, the method 1000 may bypass step 1020 and continue to step 1025.

It should further be noted that the sensor 122 being activated is only exemplary. When only the sensor 122 is activated, it may be assumed that the sensor 122 is the appropriate sensor to receive cellular signals from the MU 135 (e.g., the MU 135 is within the coverage area of the sensor 122). This determination may be made using a variety of manners. For example, if the MU 135 was associated with the WiFi network 100, the server 105 may have determined the location of the MU 135. Upon disassociation from the WiFi network 100, the server 105 may retrieve the last known location of the MU 135. Accordingly, the appropriate sensor having a coverage area in which the MU 135 was last known to be disposed may be activated. In another exemplary embodiment, all the sensors 122, 127, 132 may be activated. Those skilled in the art will understand that since the sensors 122, 127, 132 may each have a respective coverage area according to the exemplary embodiments of the present invention, an overall coverage area of the sensors 122, 127, 132 is greater than that of a single sensor. Thus, activation of all the sensors 122, 127, 132 increases a probability that a cellular signal transmitted from the MU 135 will likely be received.

In step 1025, a determination is made whether the MU 135 is operating in a mode that the sensor 122 is configured to operate. Specifically, this determination may indicate whether the sensor 122 is capable of receiving signals transmitted by the MU 135 operating with a different protocol than that of the WiFi network 100. As discussed above, the MU 135 may operate in at least two different modes. If the MU 135 is configured to operate in a third mode that uses a protocol different from the WiFi network 100 and the cellular network, then it is possible that neither the AP 120 nor the sensor 122 is configured to receive the signals broadcast from the MU 135.

The determination of whether the MU 135 is operating in a mode that the sensor 122 is configured to operate may be performed in a variety of manners. For example, the sensor 122 may broadcast a query signal. If the MU 135 is operating the mode that the sensor 122 is configured to operate, the MU 135 may receive the query signal. Consequently, the MU 135 may transmit a reply signal that the sensor 122 receives. If no reply signal is received by the sensor 122, the sensor 122 may continuously broadcast the query signal for a predetermined period of time. If the sensor 122 continuously does not receive a reply signal, then it may be assumed that the MU 135 is not operating in a mode that the sensor 122 is configured to operate. It should be noted that it may also be assumed that the MU 135 is disposed outside a coverage area of the sensor 122. In the exemplary embodiment where all the sensors 122, 127, 132 are activated, if no reply signal is received by any of the sensors 122, 127, 132, it may be assumed that the MU 135 is disposed outside the an overall coverage area provided by the sensors 122, 127, 132 or the MU 135 is operating in a different protocol than the sensors 122, 127, 132.

The method 1000 has determined that the MU 135 is not associated with the WiFi network 100 (step 1005) and the MU 135 is operating with a different protocol than the sensor 122 (step 1025). However, there is a possibility that the MU 135 is operating with a protocol of the WiFi network 100 but not associated therewith. Thus, the method 1000 continues to step 1030 where a determination is made whether the MU 135 is operating with the protocol of the WiFi network 100. If the MU 135 is operating using, for example, any of the 802.11 standards, the method 1000 continues to step 1010 where the signals from the MU 135 are received via the AP 120. If the MU 135 is not operating using the protocol of the WiFi network 1000, then the method 1000 ends as neither the AP 120 nor the sensor 122 is configured to receive the signals broadcast from the MU 135.

Returning to step 1025, if it is determined that the MU 125 is operating with the protocol of the sensor 122 (e.g., cellular), then the method 1000 continues to step 1035 where the signals broadcast from the MU 135 is received via the sensor 122. As discussed above, the signals may include parameters relating to the MU 135 such as data directly related to the MU 135 or signals used to extract parameters relating to the MU 135 such as a time to transmit, a signal strength, etc. The method 1000 continues to step 1015 where the location of the MU 135 is determined using the above described manners such as triangulation, RSSI, GPS, etc. As discussed above, the signals from the MU 135 may be forwarded to the server 105 where the server 105 determines the location or the signals from the MU 135 may be used by the sensor 122 where the sensor 105 determines the location.

As discussed above, an overall coverage area provided by the sensors 122, 127, 132 may be greater than the coverage area of the WiFi network 100. Thus, the MU 135 may be disposed within the coverage area of the WiFi network 100 or outside the coverage area.

The exemplary embodiments of the present invention enable a location to be determined for an MU that may be operating with a different protocol than a network in which a component of the network such as a server, a switch, or a sensor (e.g., sensor 122) is attempting to determine the location. As discussed above, if the MU is operating with the same protocol as the network, then signals may be received using the components of the network to determine the location of the MU. If the MU is operating with a different protocol as the network, then signals may be received using the sensor equipped to an AP of the network to determine the location of the MU. The exemplary embodiments of the present invention also enable a more accurate location to be determined relating to the MU. For example, the MU may be operating as a cellular phone. The location of the MU may be determined by the cellular network in which the MU is associated. The server of the WiFi network or the sensor may also determine the location of the MU by receiving cellular signals from the MU via the AP equipped with the sensor. If the server has access to the location determined by the cellular network (e.g., accessing a database through the communications network 140), the server may update the location of the MU that the server determined with the location of the MU that the cellular network determined. Consequently, a more accurate location may be ascertained.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a mobile device configured to operate in a first mode and a second mode, the first mode operating with a first protocol of a first network, the second mode operating with a second protocol of a second network; and
an access port of the first network configured to receive signals transmitted from the mobile device while the mobile device is operating in the first mode, the access port equipped with a sensor that receives the signals transmitted from the mobile device while the mobile device is operating in the second mode.

2. The system of claim 1, further comprising:
a server of the first network configured to determine a location of the mobile device as a function of the signals transmitted from the mobile device.

3. The system of claim 1, wherein the sensor is configured to determine a location of the mobile device as a function of the signals transmitted from the mobile device.

4. The system of claim 1, wherein the first network is a WiFi network.

5. The system of claim 1, wherein the second network is a cellular network.

6. The system of claim 2, wherein the server determines whether the mobile device is associated with one of the first network and the second network.

7. The system of claim 6, further comprising:
a database storing association data of the first network, the association data indicating whether the mobile device is associated with the first network.

8. The system of claim 6, wherein the access port broadcasts a query signal using the first protocol.

9. The system of claim 6, wherein the sensor broadcasts a query signal using the second protocol.

10. The system of claim 2, wherein the location is determined using one of a triangulation, a received signal strength indication (RSSI), and a global positioning system (GPS).

11. An access port of a first network, comprising:
a transceiver configured to receive signals transmitted from a mobile device while the mobile device is operating in a first mode, the first mode operating with a first protocol of the first network; and
a sensor configured to receive the signals transmitted from the mobile device while the mobile device is operating in a second mode, the second mode operating with a second protocol of a second network.

12. The access port of claim 11, wherein the access port is connected to a server of the first network.

13. The access port of claim 12, wherein the transceiver receives the signals transmitted from the mobile device that are forwarded to the server which is configured to determine a location of the mobile device as a function of the signals transmitted from the mobile device.

14. The access port of claim 11, wherein the sensor is configured to determine a location of the mobile device as a function of the signals transmitted from the mobile device.

15. The access port of claim 11, wherein the first network is a WiFi network.

16. The access port of claim 11, wherein the second network is a cellular network.

17. The access port of claim 12, wherein the access port receives an indication from the server that is configured to determine whether the mobile device is associated with one of the first network and the second network.

18. The access port of claim 17, wherein the transceiver broadcasts a query signal using the first protocol.

19. The access port of claim 17, wherein the sensor broadcasts a query signal using the second protocol.

20. An access port of a first network, comprising:
a first means for receiving signals transmitted from a mobile device while the mobile device is operating in a first mode, the first mode operating with a first protocol of the first network; and
a second means for receiving the signals transmitted from the mobile device while the mobile device is operating in a second mode, the second mode operating with a second protocol of a second network.
